(19) United States
(12) Patent Application Publication
(10) Pub. No.: US 2005/0265284 A1
(43) Pub. Date: Dec. 1, 2005

(54) Apparatus, and associated method, for facilitating communication handoff in multiple-network radio communication system

(76) Inventors: LiangChi (Alan) Hsu, San Diego, CA (US); Mark W. Cheng, San Diego, CA (US); ChingCheng Shih, San Diego, CA (US); Thinh Nguyenphu, Southlake, TX (US); Chinghua Cheng, San Diego, CA (US)

Correspondence Address: Docket Clerk;Scheef & Stone, L.L.P., Suite 1400, 5956 Sherry Lane, Dallas, TX, 75225, US

(21) Appl. No.: 10/962,275

(22) Filed: Oct. 11, 2004

Related U.S. Application Data
(60) Provisional application No. 60/510,694, filed on Oct. 10, 2003.

(51) Int. Cl. H04Q 7/00

(52) U.S. Cl. 370/331

(57) ABSTRACT

Apparatus, and an associated method, for facilitating inter-working between a wireless local area network and a cellular system network. A manner is provided by which to compress, or not compress, packet header parts of packet data communicated between a mobile station and a correspondent node when handoff is performed between the networks of the different network types.

### CROSS-REFERENCE TO RELATED APPLICATION

The present invention claims the priority of U.S. Provisional Patent Application No. 60/510,694, filed Oct. 10, 2003, the contents of which are incorporated herein by reference.

The present invention relates generally to a manner by which to facilitate inter-working between networks, such as a Wireless Local Area Network (WLAN) and a cellular network, of a multiple-network packet radio communication system. More particularly, the present invention relates to apparatus, and an associated method, by which to operate upon data packets that are communicated during effectuation of a communication service.

Header parts of the data packets are caused, or not caused, to be compressed or removed depending upon the network-type of the network to which the communications are to be handed-off. The operations are performed in synchronous manner at both the network and the mobile station and in manners that reduce the communication latency during the handoff of the communications.

### BACKGROUND OF THE INVENTION

The ability to communicate information is a practical necessity for many in modern society. Communication of information is effectuated by way of operation of communication stations of a communication system. Information is communicated between sending and receiving stations of the communication system by way of a communication channel that interconnects the communication stations. The sending station, if needed, converts the information that is to be communicated into a form to permit its communication upon the communication channel. And, once delivered to the receiving station, the receiving station operates to recover the informational content of the communicated information.

A wide variety of different types of communication systems have been developed and deployed, available for usage to communicate information. As communication technologies advance, advancements are implemented in new and improved communication systems, providing new and improved communication services.

A radio communication system is an exemplary type of communication system. In a radio communication system, the communication channel is defined upon a radio link that extends between the sending and receiving stations. The radio link is defined upon a portion of the electromagnetic spectrum. In contrast to wireline communication systems, a radio communication system, which uses radio channels defined upon radio links, need not interconnect communication stations by way of wireline connections.

Free of the need to position the communication stations of a radio communication system at locations permitting of wireline connections, the communication stations are positionable at locations at which wireline connections are not available. And, hence, communications are effectuable through use of a radio communication system at, and between, locations at which communications through the use of a wireline communication system would not be possible. Additionally, a radio communication system is implementable as a mobile communication system in which one or more of the communication stations is provided with communication mobility.

A cellular communication system is an exemplary type of radio communication system, implementation and use of which is widespread. That is to say, cellular communication systems have been installed throughout significant parts of the populated portions of the world. Various cellular communication standards have been promulgated, setting forth the operational parameters of different types of cellular communication systems.

Typically, a cellular communication system includes a fixed network infrastructure that includes a plurality of fixed-site base stations. The fixed-site base stations are positioned at spaced-apart locations throughout a geographical area that is to be encompassed by the communication system. Each of the base transceiver stations defines an area, referred to as a cell, from which the cellular communication system derives its name.

Portable transceivers, sometimes referred to as mobile stations, communicate with base stations by way of radio links within a frequency band allocated to communications in the communication system. A mobile station is permitted mobility. And, at successive times, the mobile station might be positioned within coverage areas of successive ones of the base stations of the network infrastructure. During an ongoing communication session, communication handoffs between successive base stations permit continued communications pursuant to the communication session as the mobile station travels through coverage areas defined by successive base stations.

New-generation cellular communication systems generally utilize digital communication techniques including, for instance, communication of packet-formatted data. Use of digital communication techniques is advantageous for various reasons, including the capability of such systems more efficiently to utilize communication bandwidths allocated to communications between communication stations. Use of digital communication techniques in a radio communication system is particularly advantageous for the particular need in a radio communication system efficiently to utilize the radio spectrum allocated thereto.

Other radio communication systems that are operable in manners analogous to operation of a cellular communication system have also been developed. For instance, wireless local area networks (WLANs) also provide for communications with mobile stations. And, wireless local area networks have also been developed and implemented that utilize digital communication techniques. Wireless local area networks generally provide for data intensive communication services but are generally of geographical scopes that are more limited than those provided by cellular communication systems.

Various inter-working procedures and protocols have been set forth, and others have been proposed, by which to permit a mobile station alternately to communicate with both a cellular communication system and with a wireless local area network. Many technical challenges remain with respect to such inter-working. Amongst the challenges are methodologies associated with handoff of communications when communication handoffs are to be effectuated, in either direction, between a wireless local area network and a network of the cellular communication system.

For instance, in an exemplary cellular communication system, such as a cellular communication system constructed pursuant to the operating protocols set forth in a so-called CDMA2000 operating system promulgated by the 3GPP2 (Third Generation Partnership Project Two), the packets communicated pursuant to, e.g., a VOIP (Voice Over Internet Protocol) communication service have their headers compressed or removed prior to transmission. For example, the RTP/UDP/IP (Real-time Transport Protocol/User Datagram Protocol/Internet Protocol) headers of the VOIP packets are compressed or removed prior to their transmission. And, an existing promulgation of the CDMA2000 operating specification sets forth relevant mechanisms by which to compress or to remove such header parts. Analogous VOIP communication services in a WLAN, conversely, do not compress of remove such header parts of the data packets.

When communications are handed off between networks of the different networks, a manner is required by which to permit continued communications without interruption while compensating for the need of the different networks to handle the header parts of the data packets in different manners. Existing inter-working protocols do not properly provide for such a mechanism.

What is needed, therefore, is a manner by which to facilitate inter-working between a WLAN and a cellular system network to handle better packet communications to permit handoff of packet communications between the different networks.

It is in light of this background information related to inter-working between a wireless local area network and a cellular system network that the significant improvements of the present invention have evolved.

### SUMMARY OF THE INVENTION

The present invention, accordingly, advantageously provides apparatus, and an associated method, by which to facilitate inter-working between networks, such as a WLAN (Wireless Local Area Network) and a cellular network, of a multiple-network packet radio communication system.

Through operation of an embodiment of the present invention, a manner is provided by which to operate upon data packets that are communicated during effectuation of a packet communication service. Header parts of the data packets are caused, or not caused, to be compressed or removed, depending upon the network-type of the network to which the communications are to be handed-off. The operations are performed both at the network and at the mobile station in synchronous manner and, through such operation, reduce communication latency during handoff of communications between the networks.

In one aspect of the present invention, improved inter-working between networks of a CDMA2000-WLAN network set is provided. A multi-mode mobile station is selectably operable in either of the CDMA2000 or WLAN networks. The mobile station handles single radio access at one time by way of which to handoff VOIP, or other packet communication, services between the CDMA2000 and the wireless local area network. The wireless local area network is, for instance but not necessarily, directly inter-worked with the same packet data service node (PDSN) of the network of the CDMA2000 system from which the mobile station is handing off communications as the wireless local area network as a wireless local area network typically provides local mobility and is usually encompassed by a single packet data service node of the CDMA2000 network.

The mobile station operates upon data packets that are communicated pursuant to the VOIP, or other packet, communication service in a first manner when the communications are handed off from the CDMA network to the wireless local area network and in a second manner when the communications are handed off from the wireless local area network to the CDMA2000 network. Header compression or removal of header parts of data packets is utilized when the mobile station communicates by way of the CDMA2000 network. But, when the mobile station is operated to communicate by way of the wireless local area network, the header parts of the data packets are uncompressed, that is, are not stripped, removed, or altered prior to communication of the data packets. When communications are handed off between networks, a packet data operator selectably operates upon the data packets, alternately to cause their compression or removal or cause their communication in uncompressed or unremoved form.

In another aspect of the present invention, the CDMA2000, or other cellular system, network also operates upon data packets in like manner. When communications are handed off between the separate network-types, the data packets that are to be communicated are selectably operated upon in manners alternately to cause compression or removal of the header part or to cause their passage in uncompressed or unremoved form. Operations of the packet data service node which the network-based operator is embodied and of the mobile station are maintained in synchronization, and a manner is provided by which to process the VOIP, or other packet communication, IP flow during the handoff transition between the networks.

In a further aspect of the present invention, a manner is provided by which to reduce communication latency when communications are handed off between networks of the different network-types. And, in the event that latency requirements can not be achieved, such as to provide a desired QOS (Quality of Service), a compensation scheme is utilized to name a quality VOIP, or other packet, communication session.

When a handoff is to be effectuated, the network with which the mobile station communicates directs the mobile station to handoff communications. The direction is, for instance, made responsive to a mobile assisted handoff procedure. Responsive to the handoff instruction, the data packets that are to be communicated are caused to be operated upon in a different manner. That is to say, when a handoff instruction is delivered to the mobile station that is communicating pursuant to a packet communication service by way of a CDMA2000 network, and the direction to handoff is delivered to the mobile station, the data packet headers of data packets to be communicated by the mobile station are caused to be passed in uncompressed or unremoved form. Analogous operations are performed at the PDSN of the CDMA2000 network part. And, conversely, when the mobile station is involved in communications with the wireless local area network and a decision is made to handoff communications of the mobile station with the wireless local area network to communications by way of a CDMA2000 network, the mobile station enables compression or removal of the data parts of the data packets that are subsequently to be communicated. And, subsequent to connection of the mobile station with the cellular system network, data packets are communicated with header parts are compressed or removed form.

Thereby, improved inter-operability is provided to a multi-mode mobile station operable alternately to communicate by way of a wireless local area network or by way of a cellular-system network.

In these and other aspects, therefore, apparatus, and an associated method, is provided for facilitating handoff of communications of a mobile station operable in a packet radio communication system pursuant to a packet communication service. The communication handoff is effectuated between a first network of a first network-type and a second network-type. A packet header operator is adapted to receive data packets that are communicated pursuant to the packet communication service. The packet header operator operates upon header parts of the data packets. The header parts of the data packets are operated upon in a first manner when the handoff is effectuated from the first network to the second network. And, the header parts of the data packets are operated upon in a second manner when the handoff is effectuated from the second network to the first network.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a radio communication system having a cellular-system network and a wireless local area network and in which an embodiment of the present invention is operable.

FIG. 2 illustrates a diagram representing call flows generated pursuant to operation of the radio communication system shown in FIG. 1 pursuant to operation of an embodiment of the present invention.

FIG. 3 illustrates a message flow diagram representative of further operation of an embodiment of the present invention in the radio communication system shown in FIG. 1.

FIG. 4 illustrates a representation of flow mapping, bi-casting, and encapsulation performed during operation of an embodiment of the present invention implemented at the radio communication system shown in FIG. 1.

FIG. 5 illustrates a representation of alternate operation of the radio communication system shown in FIG. 1 pursuant to handoff of communications between networks of the different network-types.

FIG. 6 illustrates a call flow diagram representative of exemplary operation of the radio communication system shown in FIG. 1 pursuant to operation of an embodiment of the present invention.

FIG. 7 illustrates a method flow diagram representative of exemplary operation of an embodiment of the present invention.

### DETAILED DESCRIPTION OF THE DRAWINGS

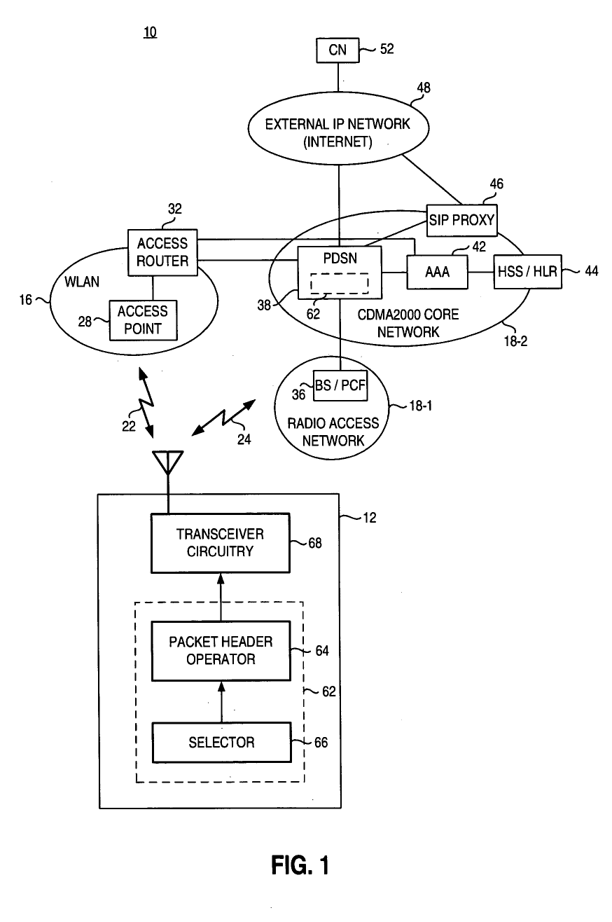

Turning first to FIG. 1, a radio communication system, shown generally at 10, provides for radio communications with mobile stations of which the mobile station 12 is representative. The radio communications permitted with the mobile station comprise a packet radio communication service, here a VOIP (Voice Over Internet Protocol) communication service, in which packet-formatted data is communicated between a network part of the communication system and the mobile station. While the following description of exemplary operation of an embodiment of the present invention shall be described with respect to its implementation in which a VOIP communication service is effectuated, the teachings of the present invention are analogously applicable to any of various other packet communication services effectuable with the, and by the, mobile station in a packet radio communication system. It should be understood, therefore, that the following description is exemplary only.

The mobile station 12 is a multi-mode mobile station separately operable to communicate in a cellular communication system and in a wireless local area network. Here, more particularly, the mobile station forms a dual mode mobile station operable in a CDMA2000-compliant cellular communication system and in an IEEE 802.11-compliant wireless local area network.

The radio communication system includes network infrastructure, here including a wireless local area network and a CDMA2000 network 18 formed of a radio access network portion 18-1 and a core network portion 18-2. During communication operations, data is communicated between the mobile station and a selected one of the networks 16 or 18. When communications are effectuated between the mobile station and the wireless local area network, the packet-formatted data communicated pursuant to the VOIP, or other, packet communication service is communicated by way of radio channels 22 of a radio air interface defined pursuant to the operation of the wireless local area network. And, analogously, when the mobile station is operable to communicate the packet-formatted data communicated pursuant to the VOIP, or other, packet communication service by way of the CDMA2000 network, the data is communicated by way of radio channels 24 of a radio air interface defined pursuant to the CDMA2000 system.

The wireless local area network includes access points, such as the access point 28, that transceives the data with the mobile station when the mobile station is positioned within the coverage are of an access point of the wireless local area network. The access point 28 is coupled to an access router 32.

The radio access network portion 18-1 of the CDMA2000 cellular communication system includes base stations and packet control functions of which a single base station and packet control function (BS/PCF) 36 is shown in the figure. The base station includes transceiver circuitry that transceives data with the mobile station. The core network 18-2 of the CDMA2000 system includes a PDSN (Packet Data Service Node) 38, an AAA (Authorization, Authentication, and Accounting) element 42, an HSS/HLR (Home Subscriber Server/Home Location Register) 44, and an SIP (Session Interface Protocol) proxy element 46.

The PDSN 38 and SIP proxy 46 are coupled to an external IP network 48, such as the internet backbone, and communication devices, here a correspondent node (CN) 52 is coupled to the external IP network. The PDSN is further coupled to the access router. And, the access router is also coupled to the AAA element 42.

End-to-end communication of VOIP data is effectuated between the correspondent node 52 and the mobile station to effectuate the VOIP communication service therebetween. When communications are effectuated using the WLAN, appropriate communication paths are formed between the correspondent node and the mobile station by way of the wireless local area network 16 and radio channels 22. And, when the communication service is effectuated by way of the CDMA2000 network, an appropriate communication path is formed through the network 18 and upon radio channels 24.

As noted previously, the packet data is treated differently depending upon whether the data is communicated by way of the wireless local area network or by way of the CDMA2000 network. And, in particular, the header parts of the packet data are compressed or removed when the packets are communicated upon the radio channels 24 of the radio air interface defined in the CDMA2000 system. But, when the data packets are communicated pursuant to the wireless local area network, the header parts of the data packets are not compressed or removed. While existing inter-working between the networks remains undefined, the communication system 10 includes apparatus 62 of an embodiment of the present invention to facilitate the handoff of the communications in a manner to account for the separate treatment of the header parts of the data packets that are communicated by way of the separate networks. First apparatus 62 is embodied at the mobile station 12 and second apparatus 62 is embodied at the PDSN 38 of the CDMA2000 network. The apparatus 62 includes a packet header operator 64 and a selector 66. The packet header operator is coupled to the transceiver circuitry 68 of the mobile station.

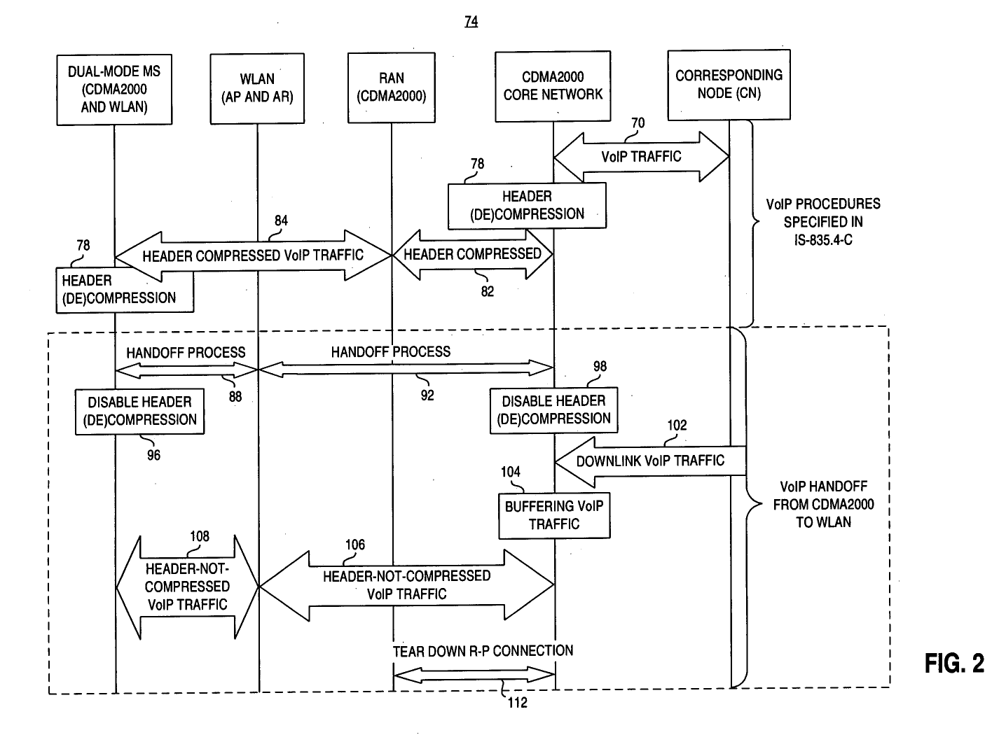

FIG. 2 illustrates a representation, shown generally at 74, representative of call flows generated during exemplary operation of the radio communication system 10, shown in FIG. 1. The call flows are representative of a VOIP communication session between the mobile station 12 and the correspondent node 52. Initially, communications are effectuated by way of the CDMA2000 network.

As indicated by the segment 76, VOIP traffic originated at the correspondent node is communicated to the DCMA2000 core network 18. Upon delivery to the core network, the data packets of the VOIP communications are compressed by a header compressor/decompressor 78. And, header-compressed data packets are communicated, indicated by the segments 82 and 84, by the core network to the radio access network and, in turn, to the mobile station. When delivered to the mobile station, the compressed header parts of the data packets are decompressed by the header compressor/decompressor 78 embodied at the mobile station. The header compressor/decompressor forms the packet header operator 64 shown in FIG. 1. Analogously, when communications are originated at the mobile station, the header parts of the data packets are compressed, or removed, by the element 78, and the data is communicated in the reverse directions, also indicated by the segments 84 and 82 for delivery to the core network 18-2. When delivered to the core network 18-2, the header parts are decompressed by the element 78, and the data packets, with the headers, are communicated to the correspondent node, again indicated by the segment 70.

Operation pursuant to handoff form the CDMA2000 network to the wireless local area network is represented, here by the segments 88 and 92. As set forth more fully in the CDMA2000 operating specification, handoff decisions are made responsive to mobile station measurement of forward pilot strength levels of pilot signals generated by a base station of the CDMA2000 radio access network. The mobile station typically measures forward pilot signal strengths of the cells in an active set of cells maintained at the mobile station. And the mobile station reports the pilot signal strength by way of a PSMM message as set forth in the CDMA2000 operating specification. Additionally, if necessary, the base station sends a handoff direct message, e.g., a UHDM message, to direct the mobile station to perform the handoff. Here, based on inter-system selection criteria, a hard handoff from a CDMA2000 network to the wireless local area network is selected. Determination is made, in one implementation, at least in part, by the mobile station.

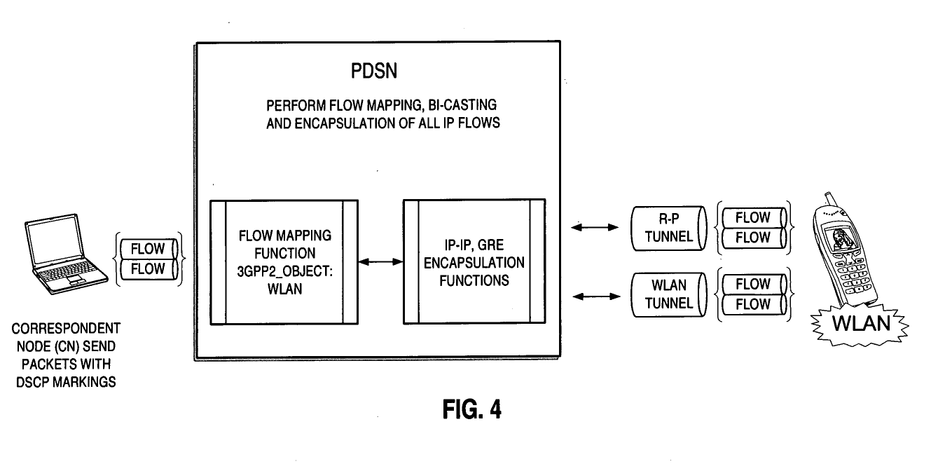

Upon selection of the handoff, the mobile station sets up a radio connection to the wireless local area network and commences authentication and authorization processes with the AR and AAA elements 32 and 42, shown in FIG. 1. Additional signaling details are set forth in FIG. 4.

In one implementation, the procedures represented by the segments 88 and 94 are performed in advance, prior to a decision to perform the handoff. That is to say, the procedures are carried out when the VOIP session is initiated but for the establishment of the WLAN radio connection. Upon subsequent handoff, only the formation of the WLAN radio connection remains to be performed.

As, here, the mobile station is handing off communications from the CDMA2000, a 3GPP2 (Third Generation Partnership Project Two) network, to the wireless local area network, mobile stations already authenticated and authorized by the CDMA2000 network prior to handoff. In one implementation, and noted above, when the mobile station determines that the handoff from the CDMA2000 network to the wireless local area network is to be performed, CDMA2000 network authentication and authorization processes are skipped and procedures proceed. However, the wireless local area network acts as control of authentication and authorization is required prior to the establishment of the WLAN connection during the handoff. After completion of the handoff, reauthentication is, if appropriate, triggered to insure proper access control to the CDMA2000 network.

Then, and as indicated by the blocks 96 and 98, header compression is disabled. Such operations are performed by the packet header operator 64, shown in FIG. 1. Down link VOIP traffic thereafter generated by the correspondent mode 52 is forwarded to the core network 18-2 and the data packets of the VOIP traffic are buffered, indicated by the block 102 at the core network. And, the data packets are forwarded to the wireless local area network 16 in header-not-compressed form, indicated by the segment 106 and then forwarded on to the mobile station 12, here indicated by the segment 108. The segment 112 is representative of tearing down of the R-P connection between the core network and radio access network 18-2 and 18-1 respectively.

In one implementation, an optional transport scheme referred to as bi-casting, is pre-configured during the handoff steps represented in FIG. 2 by the segments 88 and 94. Bi-casting is used for the dual-mode mobile station with the capability of activating both the WLAN radio and CDMA2000 radio parts of the mobile station simultaneously.

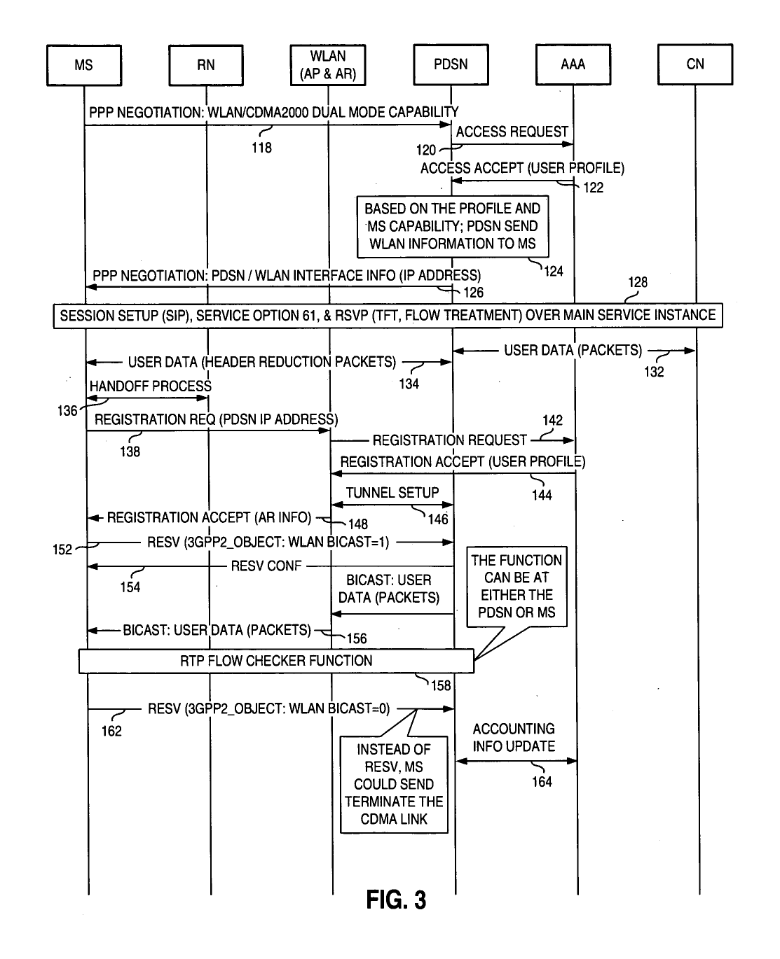

FIG. 3 illustrates a message flow 116 representative of the bi-casting message flow that also is performed pursuant to operation of an embodiment of the present invention. During the WLAN connection setup or authentication and authorization phase, mobile station needs to provide the address of the serving packet data service node 38 to the WLAN. This ensures service continuity from the packet data service node to the mobile station. After the WLAN connection is authenticated and authorized, the mobile station is aware of the WLAN interface ID, e.g., its IP address, etc. The mobile station should properly configure the PDSN to rout the specific IP flows to the proper WLAN connection with the proper flow treatment, i.e., compression or no compression, as needed.

In general, the message flow 116 involves the mobile station using RSVP-like signaling with a 3GPP2_object to install either a WLAN-packet filter with a bi-cast indicator enable or to activate the bi-cast function at the serving PDSN. Upon the installation of the WLAN-packet filter, a new tunnel is created by way of an IP-in-IP or IP-in-GRE encapsulation tunnel between the packet data service node and the mobile station. When the mobile station receives IP flows from the tunnel, the mobile station removes the outer header and routes the IP data to the application.

The segment 118 is representative of PPP negotiation by the mobile station to the PDSN. Segments 122 and 124 represent access request and accept messages communicated between the PDSN and the AAA element 42. And, in response, based on the profile and the mobile station capability, the packet data service node sends WLAN information to the mobile station. Such determinations are made at the PDSN, and are indicated by the block 124. Thereafter, and as indicated by the segment 126, PPP negotiation continues with a reply to the mobile station.

Then, and as indicated by the block 128, session set up is performed. Thereafter, user data packets are communicated between the correspondent node and the PDSN, indicated by the segment 132, and the user data is communicated between the PDSN and the mobile station, indicated by the segment 134. The handoff process is indicated by the segments 136, communicated between the mobile station and the radio access network. The mobile station provides the WLAN with its PDSN IP address, indicated by the segment 138, and a registration request provided to the AAA, indicated by the segment 142 and in acceptance other registration is returned, indicated by the segment 144. A tunnel setup procedure is carried out, indicated by the segment 146 and a registration acceptance is provided to the mobile station, indicated by the segment 148.

Thereafter, reservation signaling is performed by the mobile station, indicated by the segment 152, and a confirmation is returned, indicated by the segment 154. And, as indicated by the segment 156, user data packets are bi-cast. Then, as indicated by the block 158, RTP flow checker functions are performed, either at the PDSN or at the mobile node. And, as indicated by the segment 162, a reservation message is sent and accounting information updates are performed, indicated by the segment 164.

FIG. 4 illustrates another representation of the communication system 10, here representing the flow mapping, bi-casting, and encapsulation by way of which VOIP traffic is communicated between the correspondent node 52 and the mobile station 12, by way of the packet data service node 38.

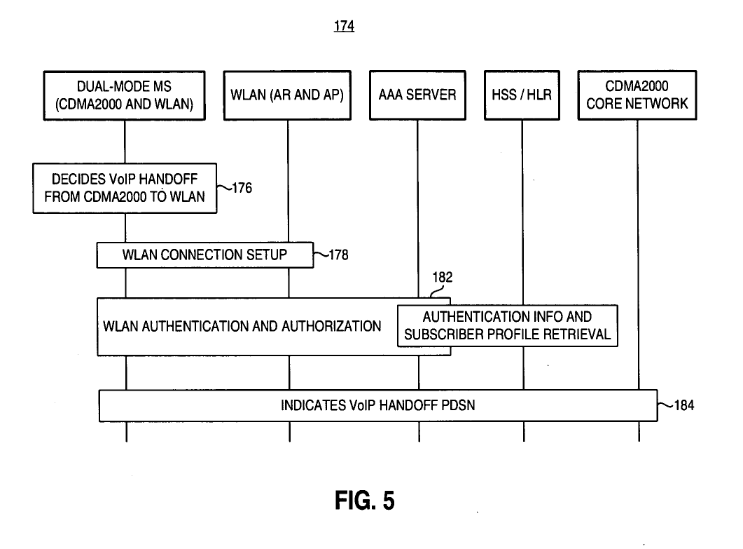

FIG. 5 illustrates a representation 174 of the handoff initiation and process relating to authentication and authorization. At block 176, a decision is made at the mobile station of the VOIP handoff from the CDMA2000 network to the wireless local area network. Then, WLAN connection setup is performed, indicated by the block 178. And, WLAN authentication and authorization is performed, indicated by the block 182. And, as indicated by the block 184, indications of the VOIP handoff is indicated to the packet data service node.

With respect again to FIG. 2, the step represented by the block 96 at which header compression is disabled, the mobile station clears up CDMA2000 service options 60/61 contexts after the WLAN radio is established for the VOIP handoff. The mobile station disables RTP/UDP/IP header reduction/removal compression and decompression functions at the mobile station. The mobile station also buffers, or discards, if necessary, reverse link VOIP IP packets. Buffered packets together with their headers already stripped off are transmitted continuously over the CDMA air interface during this transition period. An indication, e.g., a special frame that can be used to signal the end of the transition period between the VOIP with and without LLA-ROHC header compression, is sent at the end of the buffered packet so that the receiver detects the end of the transmissions and start of the reception from the WLAN.

Alternatively, if bi-casting is utilized for dual-mode mobile stations with simultaneously active WLAN and CDMA2000 radio parts, on the forward direction, the mobile station utilizes the RTP flow checker function to determine when to switch the RTP/UDP/IP flow to the WLAN radio part. The mobile station uses RSVP-like signaling with the 3GPP2_object to remove the CDMA2000 RTP/UDP/IP flow, e.g., by deleting the TFT.

Due to the QOS requirements and synchronous nature of SO 60/61, there exists about 2-3 buffered packets. With 20 ms intervals for each packet transmission, the total transmission period is approximately 60-80 ms, during which the mobile station initiates a new data instance for the WLAN connection and sets up the route for the new incoming IP packets. If earlier switching is desired due to the CDMA2000 radio condition, some buffered packets are discarded to maintain the synchronous nature of the voice packets.

In the block 98, RTP/UDP/IP header reduction/removal compression and decompression functions are disabled at the packet data service node. While the BS/PCF clears up the service option 60/61 context, the PDSN also disables the header compression operation. Here, it is assumed that the CDMA2000 air interface eventually becomes disconnected to the radio condition. Hence, no additional CDMA2000 radio signaling and procedures are required to terminate the packet data service. Alternately, after the base station sends a UHDM message, with the hard handoff indication, to the mobile station, the base station also informs the PDSN to terminate the packet data service.

At the step indicated by the block 104, the forward link VOIP traffic continues coming to the packet data service node from the external packet network. The PDSN continues to send out the buffered data packets that have their headers compressed or stripped similar to the mobile station procedure set forth with respect to the operation 96. As the header compression occurs inside the PDSN and mobile station endpoints, if configured, both sides of the packet communications are able to continue the header compression over the WLAN link after the SO 60/61 is terminated. And, at the operation indicated by the element 104, the packet data service node buffers the downlink VOIP traffic. The packet data service node buffers and selectably discards the VOIP packets based upon the VOIP QOS requirements.

The signaling represented by the segments 106 and 108 represent VOIP flows, downlink and uplink, that are carried as normal IP traffic without ROHC-LLA header compression/removal. And, at the teardown indicated by the segment 112, the R-P interface, i.e., A8, A10, and A11, for SO 60/61 VOIP services is removed. The teardown is alternately performed at any other time during the handoff procedure.

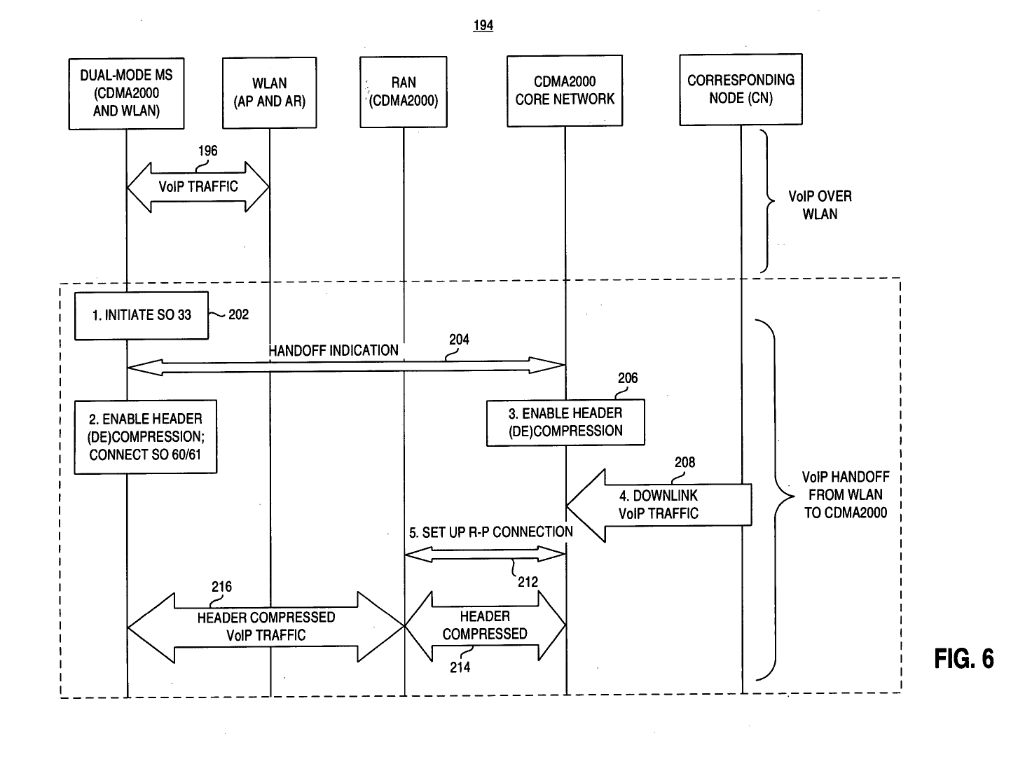

FIG. 6 illustrates a call flow 194 representative of handoff from the WLAN to the CDMA2000 network. Here, initially, the VOIP traffic communicated between the mobile station and the wireless local area network is indicated by the segment 196. In these communications, the CDMA2000 LLA-ROHC is not utilized. When a decision to hand off communications from the wireless local area network to the CDMA2000 network is made, handoff procedures commence. At the block 202, VOIP handoff is initiated. The mobile station detects that a handoff is required. The mobile station sets up an SO 33 with the packet data service node. The mobile station forms the packet data service node of the intended CDMA2000 handoff. The primitive used to carry this indication is sent by way of a main service instance, the SO 33.

Then, and as indicated by the segment 204, the RTP/UDP/IP header reduction/removal compression and decompression functions are enabled at the mobiles station. The mobile station also buffers, or discards if necessary, reverse link VOIP IP packets and sets up service options 60/61 connections. Then, and as indicated by the block 206, the RTP/UDP/IP header reduction/removal compression and decompression functions are enabled at the PDSN.

Thereafter, and as indicated by the segment 208, the forward link VOIP traffic continues arriving at the PDSN from the external packet network. The PDSN buffers the downlink VOIP traffic until the R-P interface is formed. The PDSN discards the VOIP packets based on VOIP QOS requirements. Then, as indicated by the segment 212, and R-P interface for SO 60/61 VOIP services is formed. The VOIP flows are carried, indicated by the segments 214 and 216, with LLA-ROHC header compression/removal.

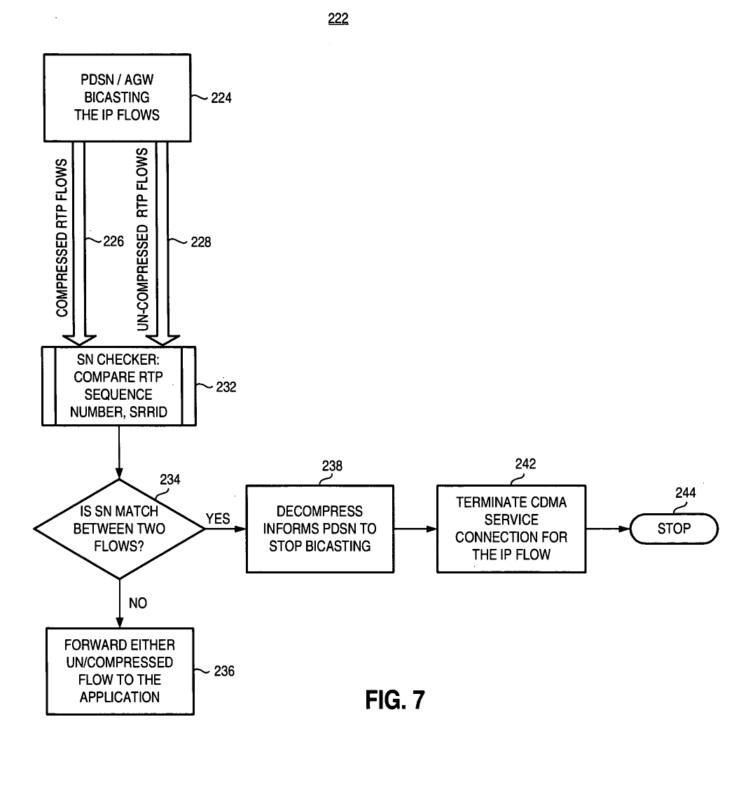

FIG. 7 illustrates an RTP flow checker function, shown generally at 222, also performed during operation of an embodiment of the present invention. First, and as indicated at the block 224, the PDSN/AGW bi-casts the IP flows. Compressed RTP flows are indicated by the segment 226, and uncompressed RTP flows are represented by the segment 228.

Then, at the block 232, an SN checker compares the RTP sequence number RSRRID of the data packets. Thereafter, and as indicated by the decision block 234, a determination is made whether there is an SN match between the two flows. If not, the no branch is taken to the block 236 and either the uncompressed or compressed flow is forwarded to the communication application. Otherwise, if a match is found between the two flows, the yes branch is taken to the block 238. At the block 238, the PDSN is informed to stop bi-casting. And, as indicated by the block 242, a CDMA service connection for the IP flow is terminated. And, the process extends to the stop block 234.

A mechanism and procedure is thereby provided by way of which to facilitate inter-working between the wireless local area network and the CDMA2000 network. Handoff of communications pursuant to a packet data communication service is provided thereby.

The previous descriptions are of preferred examples for implementing the invention, and the scope of the invention should not necessarily be limited by this description. The scope of the present invention is defined by the following claims.

1. Apparatus for facilitating handoff of communications of a mobile station operable in a packet radio communication system pursuant to a packet communication service, the communication handoff effectuated between a first network of a first network-type and a second network of a second network of a second network-type, said apparatus comprising:
a packet header operator adapted to receive data packets communicated pursuant to the packet communication service, said packet header operator for operating upon header parts of the data packets, the header parts of the data packets operated upon in a first manner when the handoff is effectuated from the first network to the second network and the header parts of the data packets operated upon in a second manner when the handoff is effectuated from the second network to the first network.

2. The apparatus of claim 1 wherein the second network of the second network of the second type comprises a Wireless Local Area Network and wherein the first manner by which the header parts of the data packets are operated upon by said packet header operator comprise a manner in which the header parts are positioned in header not-compressed form.

3. The apparatus of claim 1 wherein the second network of the second type comprises a cellular radio network and wherein the first manner by which the header parts of the data packets are operated upon by said packet header operator comprise a manner in which the header parts are positioned in header-compressed form.

4. The apparatus of claim 1 wherein said packet header operator is embodied at the mobile terminal.

5. The apparatus of claim 4 wherein said packet header operator comprises a packet header compressor, said packet header compressor selectably for compressing the header parts of the data packets.

6. The apparatus of claim 1 wherein said packet header operator comprises a first packet header part and a second packet header part, said first packet header part embodied at the mobile station and said second packet header part embodied at the first network, said first packet header part and said second packet header part operable together in synchronicity.

7. The apparatus of claim 1 wherein said packet header operator is embodied at the first network.

8. The apparatus of claim 1 wherein said packet header operator comprises a packet header compressor, said packet header compressor selectably for compressing the header parts of the data packets.

9. The apparatus of claim 8 further comprising a selector coupled to said packet header compressor, said selector for selecting whether to cause said packet header compressor to compress the header parts of the data packets.

10. The apparatus of claim 9 wherein said selector is adapted to receive indications of a handoff instruction, said selector for selecting to cause said packet header compressor to compress the header parts of the data packets when the handoff is effectuated from the first network to the second network.

11. The apparatus of claim 9 wherein said selector is adapted to receive indications of a handoff instruction; said selector for selecting not to cause said packet header compressor to compress the header parts of the data packets when the handoff is effectuated from the second network to the first network.

12. A method for facilitating handoff of communications of a mobile station operable in a packet radio communication system pursuant to a packet radio communication service, the communication handoff effectuated between a first network of a first network-type and a second network of a second network-type, said method comprising the operations of:
detecting a decision to effectuate the communication handoff between the first network and the second network;
operating upon header parts of the data packets in a first manner when the decision to effectuate the communication handoff detected during said operation of detecting comprises decision to handoff communications from the first network to the second network; and
operating upon header parts of the data packets in a second manner when the decision to effectuate the communication handoff detected during said operation of detecting comprises decision to handoff communications from the second network to the first network.

13. The method of claim 12 wherein the decision detected during said operation of detecting comprises a network-generated decision, said method further comprising the operation of delivering the network-generated decision to the mobile station.

14. The method of claim 12 wherein the first manner upon which the header parts of the data packets are operated comprises a manner in which the header parts are compressed.

15. The method of claim 12 wherein the second manner upon which the header parts of the data packets are operated comprises a manner in which the header parts are uncompressed.

16. The method of claim 12 further comprising the operation of authenticating the mobile station with the second network when the decision detected during said operation of detecting comprises decision to handoff communications from the first network to the second network.

17. The method of claim 12 further comprising the operation of authenticating the mobile station with the first network when the decision detected during said operation of detecting comprises decision to handoff communications from the second network to the first network.

18. The method of claim 12 further comprising the operation prior to said operation of detecting, of authenticating the mobile station with both of the first network and the second network.

19. The method of claim 12 wherein said operation of operation of operating upon the header parts of the data packets in the first manner is performed at both the mobile station and the first network.

20. The method of claim 12 wherein said operation of operating upon the header parts of the data packets in the second manner is performed at both the mobile station and the first network.
